(19) United States
(12) Patent Application Publication
(10) Pub. No.: US 2005/0052455 A1
(43) Pub. Date: Mar. 10, 2005

(54) Effecient display update from changing object graphics

(75) Inventors: Timothy Merrick Long, Lindfield (AU); Stephen Edward Ecob, Chatswood West (AU); Scott Bradley, St Leonards (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha

(21) Appl. No.: 10/502,974

(22) PCT Filed: Jan. 31, 2003
(86) PCT No.: PCT/JP03/00994

(30) Foreign Application Priority Data
Feb. 1, 2002 (AU) PS 0287

(51) Int. Cl. G06T 15/40

(52) U.S. Cl. 345/422

(57) ABSTRACT

Method, apparatus and program are disclosed for rendering a series of raster image frames from object graphic elements (1000, 1020). At least one old fill run (A1, A2, A3, A4) is retained during the rendering of a first frame (A). The retained fill run is compared with at least one new fill run (B1, B2, B3, B4) required for a subsequent frame (B). For at least one of the new fill runs (B1, B4), the generation of pixel data for at least part of the new fill run is suppressed and pixels retained from the first frame are used instead.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### TECHNICAL FIELD

The present invention relates to the rendering of object graphic elements into raster pixel images and, in particular, to efficient frame-store updates in the presence of changes to the object graphic elements.

### BACKGROUND ART

Most object-based graphics systems utilise a frame store or page buffer to hold a pixel-based image of the page or screen. The outlines of the objects are calculated, filled and written into the frame store. For two-dimensional graphics, objects appear at a particular z-level in the image. Those objects that appear in front of other objects are simply written into the frame store after the background objects, thereby replacing the background objects on a pixel-by-pixel basis. This is commonly known in the art as the “Painter's Algorithm”. Such objects are considered in priority order, from the rearmost object to the foremost object. Typically, each object is rasterized in scan line order and pixels are written to the frame store in sequential runs along each scan line.

A problem with this technique is that many of the pixels that are painted (ie. rendered), are also over-painted by later objects. The painting of the pixels with the earlier objects therefore transpires to be a waste of time and computing resources.

There are techniques that overcome the over-painting problem. In one technique, pixels are produced in raster order on a whole image basis rather on a per-object basis. On each scan line, the edges of all objects that intersect that scan line are held in order of increasing coordinate of intersection within the scan line. These points of intersection, or edge crossings, are considered in turn and used to toggle an array of active flags. There is one active flag for each object priority that is of interest on the scan line. Between each pair of edges considered, which thereby define a span of pixels therebetween, the color data for each pixel that lies between the edges is generated using a priority encoder (or equivalent software routines in software implementations). The priority encoder operates on the active flags to determine which priority is topmost, and using the paint associated with that priority for the pixels of the span between the two edges. In preparation for the next scan line, the coordinate of intersection of each edge is updated in accordance with the nature of each edge. For example, for simple straight-line vectors, a delta-x value is added to the current coordinate of intersection to get the coordinate of intersection on the next scan line. Adjacent edges that become mis-sorted as a result of this update are swapped. New edges for objects that start on the new scan line are also merged into the list of edges. This technique has been referred to, by its developers, as the “Quixel Algorithm”.

The Quixel Algorithm has the significant advantage that there is no over-painting. Further, in hardware implementations, the object priorities can be dealt with in constant order time (typically one clock cycle), rather than order N time (where N is the number of priorities). Even in software implementations, the priorities can typically be dealt with in constant time, with occasional data-dependent exceptions, or log N time. These properties give the Quixel Algorithm a significant speed advantage over the well-known Painter's Algorithm for converting a set of graphic objects into a raster image, especially when there are overlapping objects.

It is common in interactive graphic systems to maintain a frame-store that is refreshed to a display, such as a CRT or LCD screen. In such systems, the image represented on the display typically has high frame coherence. That is, one frame is very much like the next. Typically only a sub-set of the object graphic elements that contribute to the image on the display are changed between successive frames. A number of techniques have been developed to take advantage of this high inter-frame coherence to minimise the amount of computationally intensive pixel rendering work that needs to be performed.

When using the Painter's Algorithm to refresh a display from a set of object graphics, these techniques typically involve observation of the difference that has occurred in the object graphics that contribute to the display. A bounding box or more complex region description may be generated by a comparison with the difference to thereby partition the display area into areas that will remain unchanged by the change to the graphic objects, and regions that will change and thus require refreshing. The object graphic elements are then rendered. Typically however, objects that lie entirely outside the refresh region are excluded and pixel generation only occurs within the refresh region.

This technique can significantly reduce display refresh time, but still suffers from a number of disadvantages. For example, it is common for a small part of a large object to change. It is often computationally prohibitive to perform interior analysis of objects to determine the actual region of change, so an excessively large refresh region is estimated instead. Further, changes are often made to object graphic elements that, for the majority of pixels they generate, there is no change in the final image. For example, when moving a large red rectangle by a few pixels, most of the pixels remain red. Again, interior analysis of every object to detect such cases is often computationally prohibitive, and so, again, excessively large refresh regions are used. Similarly problematic situations are common. These techniques still suffer from the over-painting inefficiency that is inherent in the Painter's Algorithm.

Although not described, such techniques may be applied to the Quixel Algorithm to alleviate the over-painting inefficiency, but they would still suffer from the other problems.

It is the object of the present invention to substantially overcome, or at least ameliorate, one or more deficiencies of known arrangements.

### DISCLOSURE OF INVENTION

According to a first aspect of the invention, there is provided a method of rendering a series of raster image frames from object graphic elements wherein at least one old fill run is retained during the rendering of a first frame and the retained fill run is compared with at least one new fill run required for a subsequent frame and for at least one new fill run suppressing the generation of pixel data for at least part of the new fill run and instead using pixels retained from the first frame.

Preferably, the descriptions of the retained fill runs are stored in an ordered list. Further, advantageously, a number of retained fill run descriptions is limited to less than a number required for a complete reproduction of the first frame.

According to a second aspect of the invention, there is provided a method of rendering a plurality of raster image frames, the method comprising the steps of:
(a) rendering a first frame and retaining first data describing fill runs of pixels of the first frame; and
(b) rendering a second frame to update the pixels of the first frame, the rendering comprising the sub-steps of:
   (ba) determining second data describing fill runs of pixels of the second frame;
   (bb) comparing the second data with the first data; and
   (bc) generating new pixels using the second data, and over-writing pixels in the first frame, when the comparison indicates a different pixel value may result.

According to another aspect of the invention, there is provided an apparatus for implementing any one of the aforementioned methods.

According to another aspect of the invention there is provided a computer program product including a computer readable medium having recorded thereon a computer program for implementing any one of the methods described above.

Other aspects of the invention are also disclosed. These include a server arrangement configured to generate data for optimised rendering using runs of pixels and a remote device configured to receive the optimised data from the server to aid speedy rendering.

The above-noted object is preferably achieved by modifying the Quixel Algorithm, such that during the rendering of a first frame, certain runs of pixel fill information are retained. Then, during a subsequent frame render, these runs are compared with the new runs of pixel fill information that would be used to generate the new frame. Where the comparison indicates that spans of pixels present in the already-rendered frame already have the desired values, the filling of these spans of pixels is avoided. Also, a new list of pixel fill run information is retained so that the process may be repeated for subsequent frames.

### BRIEF DESCRIPTION OF DRAWINGS

At least one embodiment of the present invention will now be described with reference to the drawings, in which:

FIG. 1 is a schematic block diagram representation of a data flow for the prior art Quixel Algorithm;

FIG. 2 is a representation similar to FIG. 1 but showing a modification according to a present disclosure;

FIG. 3 is a schematic block diagram representation of a computer system in which the arrangements described herein may be implemented;

FIG. 4 illustrates data flow of a preferred implementation of the arrangement of FIG. 2;

FIGS. 5A to 5C shows examples of objects, steps, edges and fills;

FIGS. 6A and 6B are detailed representations of the arrangement of FIG. 4;

FIGS. 7A and 7B are flowcharts depicting operation of the edge processing module;

FIG. 8 illustrates the situation of edge overlap;

FIGS. 9A and 9B are flowcharts depicting operation of the z-level activation module;

FIG. 10 illustrates the fundamental operation of the run-culling module;

FIG. 11 is a flowchart depicting operation of the run-culling module; and

FIG. 12 depicts operation of the fill generation module.

### BEST MODE OF CARRYING OUT THE INVENTION

Where reference is made in any one or more of the accompanying drawings to steps and/or features, which have the same reference numerals, those steps and/or features have for the purposes of this description the same function(s) or operation(s), unless the contrary intention appears.

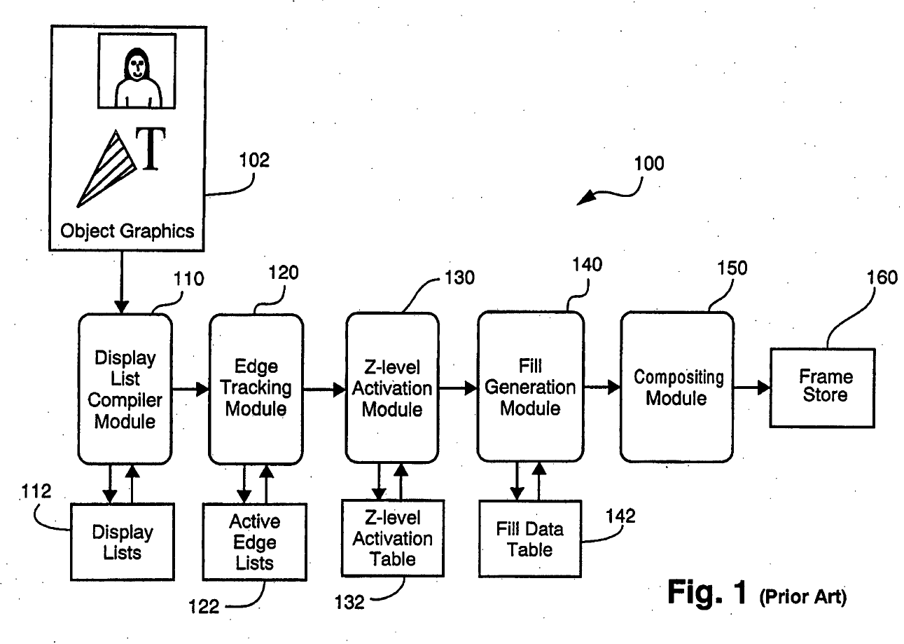

FIG. 1 shows a prior art renderer 100 based on the aforementioned Quixel Algorithm. In FIG. 1, graphic object descriptions 102 are input to a display list compiler module 110 which interprets the individual graphic objects to compile and store one or more display lists 112 of individual images desired to be rendered. Typically the images form a displayable sequence thereby depicting animation of a graphic object scene. Once formed, each display list 122 may be rendered to provide a single frame of the sequence. For rendering, an edge tracking module 120 initially examines the objects in a display list 112 to determine a list of active edges 122 that form the image being rendered. The activity of edges is typically determined in raster-scan order and is provided to a z-level activation module 130. The z-level activation module 130 determines, for each edge crossing on each scan line, those objects that are active in the rendered image on the particular scan line in a span between an adjacent pair of edges. This is typically determined with the aid of a table 132. For those entries in the table 132 for a span, the objects are ranked in their priority or z-order. The top-most opaque object in the table 132 acts to exclude all objects beneath in the z-order, and that object, together with any higher-ordered transparent objects, are output for the span to a fill generation module 140. The module 140 examines a table 142 to find the fill color for each object output from the module 130. A compositing module 150 then operates to composite actual pixel values from the fill values for the various objects across the span. The pixel values for the span are output to a frame store 160. Rendering proceeds for each span on the scan line, before moving to the next scan line, until the frame store is filled with a frame of pixel data that may be output to a display.

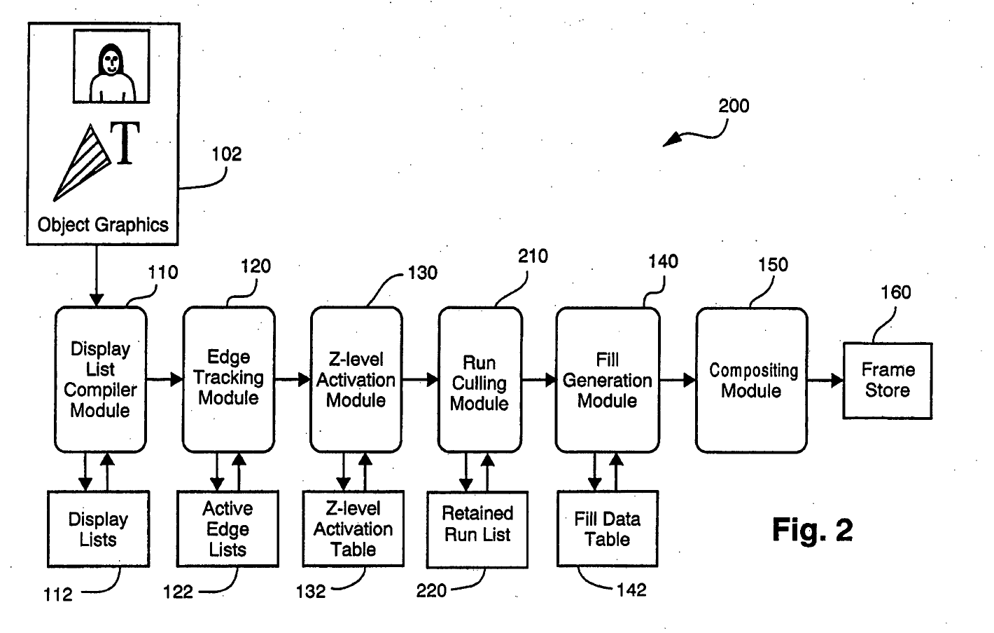

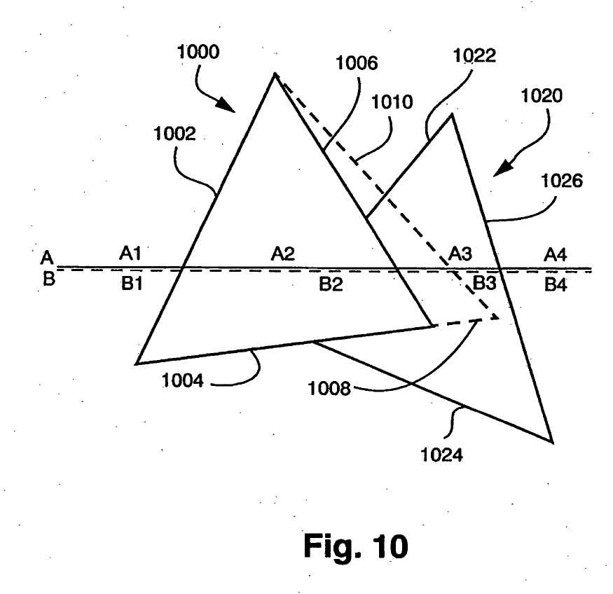

FIG. 2 shows a renderer 200 illustrating the change to the arrangement of FIG. 1 to include a process 210 according to the present disclosure, the preferred embodiment of which has been referred to herein as a “thin client imaging engine”, or “TCIE”. In FIG. 2, a run culling module 210 and associated retained run list 220 are inserted into the rendering process between the z-level activation module 130 and the fill generation module 140. Qualitatively, the run culling module 210 operates in the fashion depicted in FIG. 10, which will now be described.

FIG. 10 shows an image formed by a triangle 1000 partially overlying and obscuring a triangle 1020. The triangle 1000 is formed by edges 1002, 1004 and 1006, whereas the triangle 1020 is formed by edges 1022, 1024 and 1026. Shown is a scan line, termed A in a first frame. The scan line has a span A1 between the left periphery of the image and the edge 1002, a span A2 between the edges 1002 and 1006, a span A3 between edges 1006 and 1026, and a span A4 between the edge 1226 and the right periphery of the image. The run length of each of the spans A1-A4 may be determined arithmetically from the x-crossing of the respective edge with the scan line in question.

In a second, subsequent frame, the triangle 1000 changes shape, as depicted in FIG. 10 by a new edge 1010 replacing the edge 1006. An extension 1008 of the edge 1004 becomes visible as a consequence. The same scan line in the second frame, can be termed B. The scan line has a span B1 between the left periphery and edge 1002, span B2 between edges 1002 and 1010, span B3 between edges 1010 and 1026 and span B4 between edge 1026 and the right periphery. The run length of each of the spans B1 to B4 may also be determined as before.

The run culling module 210 operates, for the first frame, to retain in the list 220, various details of the spans A1, A2, A3 and A4. When processing the same scan line on the next frame, the run culling module 210 is used to determine those pixel values in the frame store 160 for that scan line that are required to be altered by virtue of any changes in the spans. This is done through a comparison of the spans B1, B2, B3 and B4 with those stored in the run list 220. The spans are preferably processed in raster order, as such is the manner in which they are generated. In this example, span B1 is compared with A1. Since these are identical, the span B1 contributes no change to the image and may be discarded from the present rendering, whilst the span A1 remains displayed by virtue of being stored in the frame store 160 and retained in the run list 220, for processing with the next frame. In this description, the discarding of a span is termed “culling” and the retention of a span is termed “consuming”.

Span B2 is then compared with A2. These have the same start location, whilst B2 is longer. Therefore A2 is consumed and that part of B2 that corresponds to A2 is culled, creating a new span B2¹ representing that span between edges 1006 and 1010. B2¹ is then compared with A3 and are found to be different. Therefore, B2¹ is passed to the fill generation module 140 for rendering and stored in the run list 220. Since A3 is longer than B2¹, the representation of A3 in the list 220 is shortened to A3¹, being that span between edges 1010 and 1026.

Span B3 is then compared with span A3¹. As these have the same end point, B3 is culled and A3¹ is consumed. Span B4 is then compared with A4. Since these are identical, B4 is culled and A4 is consumed.

The example of FIG. 10 shows that although the object forming part of the image has changed, that change can be interpreted by the run culling module 210 to necessitate actual rendering of only part of the scan line in question. In the present case, the part is the span between edges 1006 and 1010. Thus, for many pixels on the scan line, fill generation and compositing are avoided thereby facilitating improvements in rendering speed.

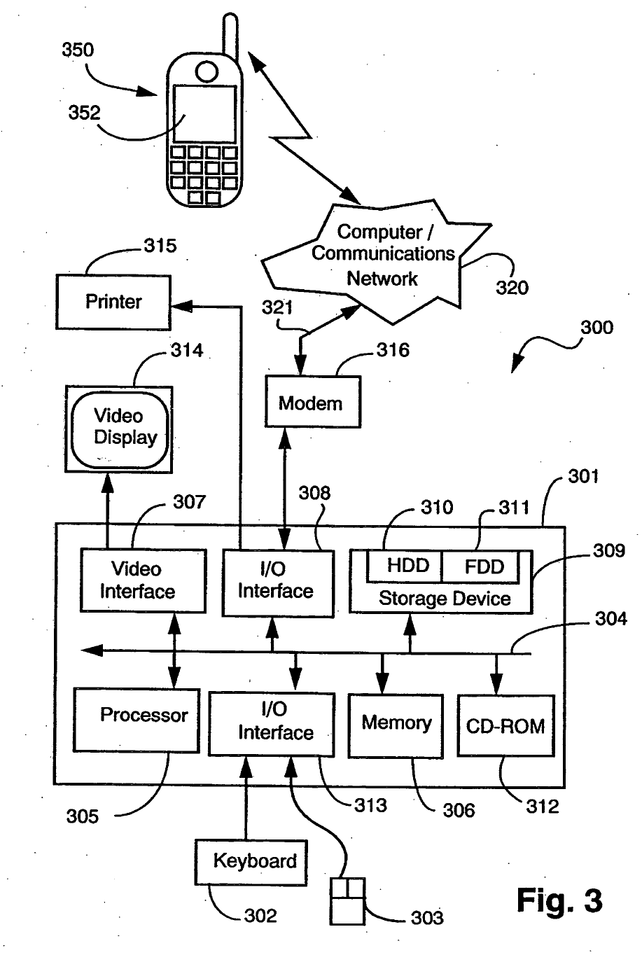

The arrangements of FIGS. 1 and 2 may each be practiced using a general-purpose computer system 300, such as that shown in FIG. 3 wherein the processes of FIG. 1 or 2, may be implemented as software, such as an application program executing within the computer system 300. In particular, the processing steps of FIG. 1 or 2 are effected by instructions in the software that are carried out by the computer. The software may be divided into two separate parts; one part for carrying out the rendering methods; and another part to manage the user interface between the latter and the user. These parts may be further divided into modules of software code which implement the processes and methods noted above and to be described. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for animated rendering of graphic objects.

The computer system 300 comprises a computer module 301, input devices such as a keyboard 302 and mouse 303, output devices including a printer 315 and a display device 314. A Modulator-Demodulator (Modem) transceiver device 316 is used by the computer module 301 for communicating to and from a communications network 320. The modem 316 may be, for example, connectable via a telephone line 321 or other functional medium. The modem 316 can be used to obtain access to the Internet, and other network systems, such as a Local Area Network (LAN) or a Wide Area Network (WAN). In this example, the network 320 couples to a cellular mobile telephone handset 350 having a pixel-based, relatively large, display screen 352. The computer module 301 may, in some implementations, represent a server computer operable across the network 320.

The computer module 301 typically includes at least one processor unit 305, a memory unit 306, for example formed from semiconductor random access memory (RAM) and read only memory (ROM), input/output (I/O) interfaces including a video interface 307, and an I/O interface 313 for the keyboard 302 and mouse 303 and optionally a joystick (not illustrated), and an interface 308 for the modem 316. A storage device 309 is provided and typically includes a hard disk drive 310 and a floppy disk drive 311. A magnetic tape drive (not illustrated) may also be used. A CD-ROM drive 312 is typically provided as a non-volatile source of data. The components 305 to 313 of the computer module 301, typically communicate via an interconnected bus 304 and in a manner that results in a conventional mode of operation of the computer system 300 known to those in the relevant art. Examples of computers on which the described arrangements can be practised include IBM-PC's and compatibles, Sun Sparcstations or alike computer systems evolved therefrom.

Typically, the application program is resident on the hard disk drive 310 and read and controlled in its execution by the processor 305. Intermediate storage of the program and any data fetched from the network 320 may be accomplished using the semiconductor memory 306, possibly in concert with the hard disk drive 310. In some instances, the application program may be supplied to the user encoded on a CD-ROM or floppy disk and read via the corresponding drive 312 or 311, or alternatively may be read by the user from the network 320 via the modem device 316. The software can also be loaded into the computer system 300 from other computer readable media, examples of which can include magnetic tape, a ROM or integrated circuit, a magneto-optical disk, a radio or optical/infra-red transmission channel between the computer module 301 and another device, a computer readable card such as a PCMCIA card, and networks such as the Internet and Intranets, thereby including e-mail transmissions and information recorded on websites and the like. The foregoing is merely exemplary of relevant computer readable media. Other computer readable media may alternately be used.

The arrangements of FIGS. 1 and 2 may alternatively be implemented in dedicated hardware such as one or more integrated circuits performing the functions or sub-functions of object-based rendering. Such dedicated hardware may include graphic processors, or one or more microprocessors and associated memories.

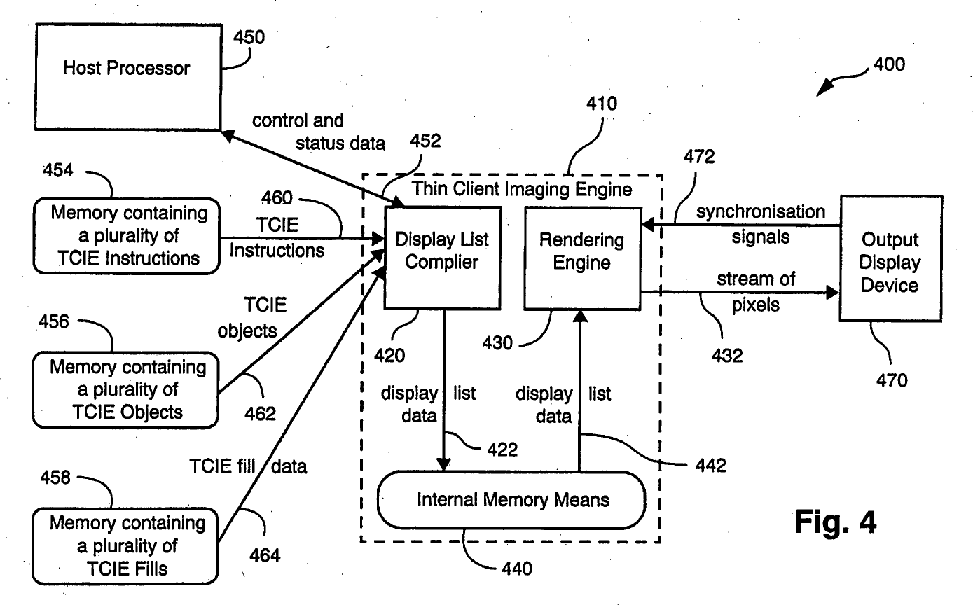

FIG. 4 illustrates the data-flow of a rendering system 400 including a thin client imaging engine (TCIE) 410. The TCIE 410 has two main functional units, a first functional unit being a display list compiler 420 and a second functional unit being a rendering engine 430. The display list compiler 420 operates to fetch and parse display object data stored in a memory 454 containing a plurality of instructions, a memory 456 containing a plurality of objects, and a memory 458 containing a plurality of fills. The memories 454, 456 and 458 may be implemented in the RAM 306 and the contents thereof generated by a host processor 450 which may also provide/receive control and status data 452 to/from the TCIE 410.

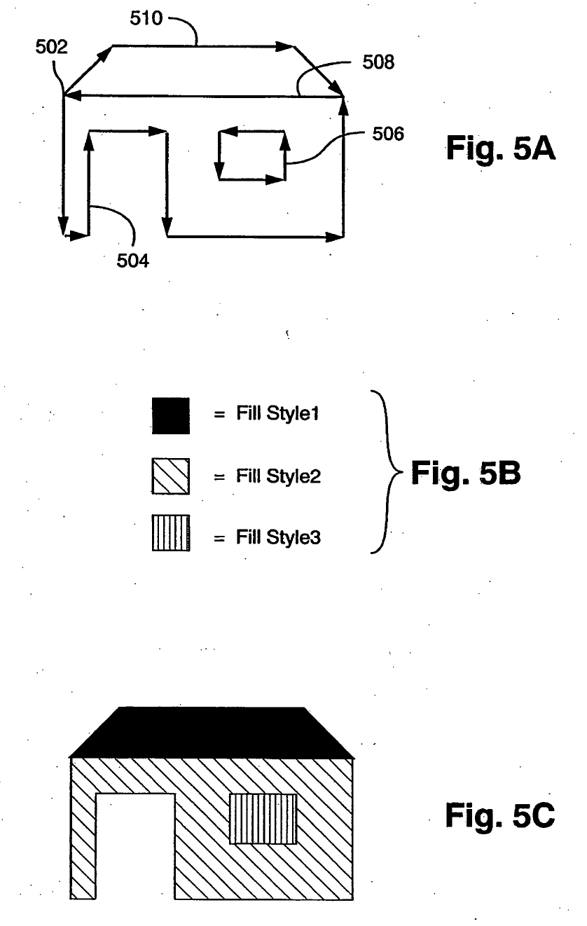

FIGS. 5A to 5C shows an example of a displayed object in FIG. 5C, and its component edges in FIG. 5A and fill styles in FIG. 5B. Objects are two-dimensional display primitives that are described in memory by a plurality of edge-lists, each edge-list being described by a plurality of coordinates. The coordinates describe new drawing positions, and straight lines. New drawing positions are described by a single coordinate, and straight lines are described by a pair of coordinates. Straight lines use the two coordinates to define start and end points of the line. Curves are typically implemented as quadratic Bezier curves, wherein a first coordinate defines the start of the Bezier curve, a second coordinate defines the control point, and a third coordinate defines the end point of the Bezier curve. The coordinates of an edge-list are stored as a sequence of relative steps, which reduces memory storage requirements and also determines the direction of edges. Edge-lists collectively describe the outline of a shape. Objects have their own coordinate space, and therefore have their own origin to which edges are relatively drawn. In FIG. 5A, point 502 represents the origin of the “house” object. An object always contains two additional, specially marked bounding coordinates, that unlike the other coordinates, do not describe how part of the object is displayed. Rather, the two bounding coordinates indicate a bounding box within which all drawing edges are contained. The first bounding coordinate specifies the top left corner of the bounding box, and the second bounding coordinate defines the bottom right corner of the bounding box.

A fill is a display primitive used to describe how part of the display enclosed by a subset of an object's edge-list should be colored. For example, a basic fill describes a solid color such as red. Two fills are associated with each edge-list—a first fill to be rendered to the left of the drawing direction of that edge-list, and a second fill to be rendered to the right of the drawing direction of that edge-list. The main styles of fill are a simple color, a linear blend described by a plurality of colors, a radial blend described by a plurality of colors, or a bitmap image. All of these fill styles support a transparency channel. It is noted that when an edge does not reference a fill on either its left of right side, a value, fill=0, is used.

In FIGS. 5A-5C, edge 504 is a straight edge vector with left fill=2 and right fill=0. Edge 506 is a straight edge vector with left fill=3 and right fill=2. Edge 508 is a straight edge vector with left fill=2 and right fill=1, and edge 510 is a straight edge vector with left fill=0 and right fill=1.

Returning to FIG. 4, instructions, stored in the memory 454, describe how and when objects 462, stored in the memory 456, are to be rendered on an output display device 470. The display list compiler 420 processes data of objects as instructed by instructions, and places the result of this processing, being display list data 422, into a memory means 440 for use by a rendering engine 430. The rendering engine 430 converts display list data 422 into pixels that are passed to a frame store (eg. 160). The frame store 160 is continuously refreshed onto a physical display 470 such as a CRT or LCD.

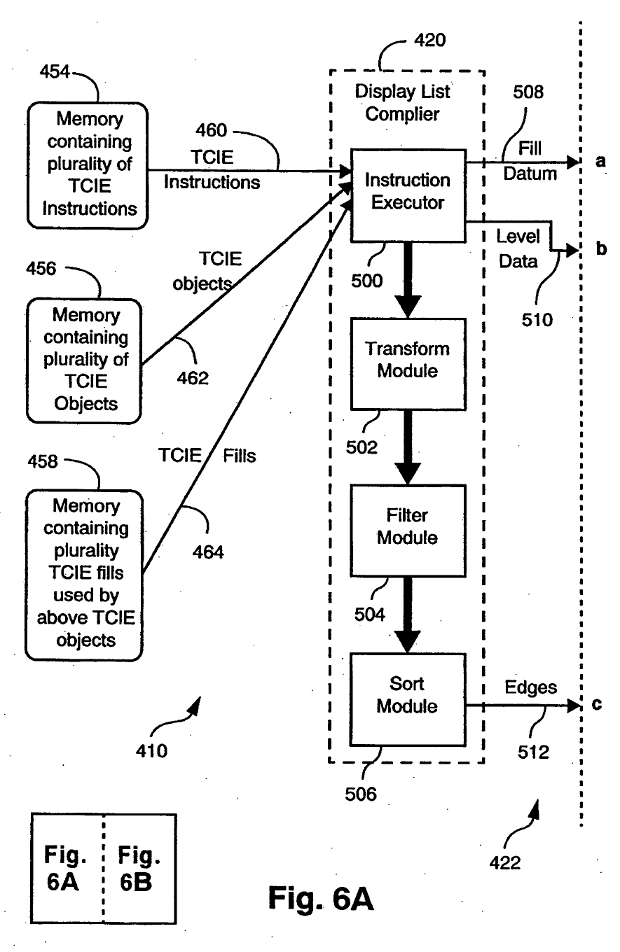

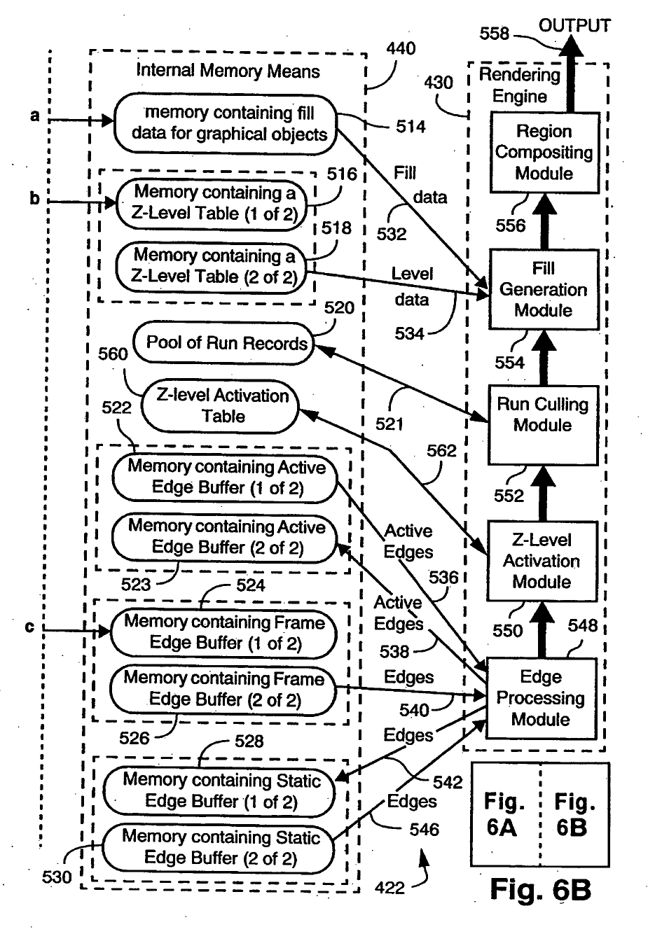

FIGS. 6A and 6B provide a more detailed illustration of the system 400, with rectangular boxes representing functional modules of the display list compiler 420 on the left, and the rendering engine 430 on the right. Rounded boxes are used to represent memory means. On the left of FIG. 6A, the memory means 454, 456 and 458 for containing the plurality of instructions 460, objects 462, and fills 464 respectively are repeated from FIG. 4.

In one embodiment, the functional modules are implemented as pipelined hardware processes, and each module may implement a first-in-first-out (FIFO) buffer for receiving messages from the previous module. Those experienced in the art of hardware development will appreciate that by pipelining hardware processes, the throughput of data passing serially through such processes is maximized. In the preferred embodiment, the TCIE 410 is implemented as software running on a general-purpose processor, such as the processor 305 of FIG. 3. In this embodiment, the functional modules are implemented as program functions that are executed by one or more threads, and messages are implemented as synchronous function calls or as asynchronous inter-thread signals with associated shared memory. The functional modules are now described in the order of which display data passes through.

In FIGS. 6A and 6B, an instruction execution module 500 is responsible for fetching and parsing the display object data. The module 500 may receive instructions directly from the host processor 450, or may be commanded by the host processor 450 to fetch instructions from the memory 454. Some examples of instructions that may be executed in a specific embodiment of the TCIE 410 can now be described.

INST_PLACE_OBJECT is an instruction that commands the TCIE 410 to render an object on an output display device 470. The parameters of INST_PLACE_OBJECT include a reference to an object to be rendered, and a transformation matrix that specifies a desired position, scale and orientation of that object on the display. When the instruction execution module 500 executes an INST_PLACE_OBJECT command, it sequentially reads edges of the referenced object from the memory 456, and passes edge data, along with references to their associated left and right fill data, to a transform module 502. The instruction execution module 500 also passes a transformation matrix parameter (of the INST_PLACE_OBJECT instruction) with the object edges to the transform module 502.

INST_WRITE_FILL is an instruction that commands the instruction execution module 500 to write the fill data 464 to a given location within a memory 514 containing fill data for graphical objects. The rendering engine 430 uses the fill data 532 when the engine 430 generates the stream of pixels to the frame store 160. When an INST_PLACE_OBJECT is executed for placing an object on the output display device 470, any fill data referenced by the edges of that object should previously have been written to the memory 514 by means of prior calls to INST_WRITE_FILL.

Sometimes INST_PLACE_OBJECT instructions may position objects on the output display device 470 such that they overlap. Specifically, this represents a situation in which a subset of pixels of the output display device 470 have an output color that is determined by a plurality of fill data 532 in the memory 514 containing fill data for graphical objects. When this happens, some objects will have been expected to appear to be in front of or behind other objects when viewed on the output display device 470. The TCIE 410 implements a z-level table 516, 518 to facilitate this, in which each fill datum 508 is associated with a z-level 510 in the z-level table 516, 518. Each z-level 510 is provided with a fixed and unique priority, and the z-level table is ordered from lowest priority to highest. Each z-level 510 also references a fill datum that defines the color of that z-level 510. Thus a fill datum 508 referenced by z-levels with lower positions in the table 516, 518 are to be rendered such that they appear to be behind or underneath fill datum 508 referenced by z-levels 510 with higher positions. The INST_WRITE_FILL instruction causes the instruction execution module to associate a fill datum 508 with a z-level 510.

INST_SHOW_FRAME is an instruction used to stop the instruction execution module 500 from fetching and/or processing further instructions until the output display device 470 is expecting display data for a new frame.

In the following descriptions of the TCIE functional modules, coordinates which step from pixel-to-pixel along a scan line of the display will be referred to as X— coordinates, and coordinates which step from scan line to scan line will be referred to as Y-coordinates.

The next functional module through which data passes is the transform module 502. The transform module 502 applies a transformation matrix received from the instruction execution module 500 to the coordinates of edges also received from the instruction execution module 500. After being processed by the transform module 502, the edges are described by a start X,Y coordinate and an end X,Y coordinate in display space, and are passed along with references to their associated left and right fill datum to a filter module 504.

The filter module 504 discards all edges passed to it by the transform module 502 that would not affect the display at all, either because the edges are horizontal, or the edges have coordinates that all lie outside the bounds of the display. Some edges may only partially affect the display. Edges having a start coordinate outside the bounds of the display, and an end coordinate within the bounds of the display, will appear to enter the display at some intermediate coordinate (ie. where that edge intersects the bounds of the screen). For such edges, the filter module 504 calculates a new start coordinate for the edge, equal to the intermediate coordinate where the edge enters the screen. The filter module 504 also appends a vertical direction flag to the edge, and if necessary, swaps the start and end coordinates of edges to ensure the start coordinate of the edge has a lower Y coordinate than the end coordinate of the edge. For example, an edge entering the filter module with a start coordinate of (5, 22) and an end coordinate of (8, 4) would have the start and end coordinates swapped by the filter module, since 4 is less than 22. A vertical direction flag is set for edges that have their coordinates swapped, to indicate that those edges are upwards-going edges. This step is necessary as the rendering engine 430 relies on edges being presented in this manner. The vertical direction flag is also important so that fill data referenced by the edge remains associated with the correct (left and right) side of that edge.

The next module of the display list compiler 420 is a sort module 506, which receives edges from the filter module 504. The received edges are to be sorted first by their start Y display position, and then by their start X display position. The sorted edges 512 are placed in the internal memory means 440 from where they can be read and processed by the rendering engine 430. Edges are written to a part of the internal memory means 440, labelled the frame edge buffer 524, 526. All edges that are used to describe the current frame of output data must be present in the frame edge buffer 524, 526 before the rendering engine 430 needs them. The frame edge buffer 524, 526 is preferably implemented as a double buffer. While the display list compiler 402 processes and sorts edges into a first frame edge buffer 524, the rendering engine 430 may thus generate display output from a second frame edge buffer 526 that was prepared by the display list compiler 420 previously. The frame edge buffers 524, 526 are then swapped once the rendering engine 430 has finished outputting display data for the current frame, so that the rendering engine 430 can begin to process the edges provided by the display list compiler 420 for the next frame.

The rendering engine 430 requires that edges for a frame to have been written to the frame edge buffer 524, 526 in “scan order”. “Scan order” is the order in which the display device receives and refreshes its display data. For the purpose of this description, scan order is assumed to begin with the top-left-most position, or pixel, of the display. Scan order then follows the top-most row of pixels of the display, increasing from left to right, until the top-right-most pixel of the display is reached. Scan order then continues from the left-most pixel of the next top-most row, again increasing from left to right. Scan order then continues in this manner until the last display pixel is reached, the last pixel being that of the bottom-right-most position of the display. This scan order is often termed “raster scan order”.

The sort module 506 preferably uses a bucket radix-sorting algorithm to sort all edges for a frame into the internal memory means 440 such that their start coordinates are in scan order. Those experienced in the art of software or hardware development will be aware that the radix-sorting algorithm can sort elements in order N time (where N is the number of elements to be sorted). The radix-sorting algorithm requires one or more iterations through all the elements, depending on the available memory means. The first iteration of the sort can be performed while the sort module is still receiving the edges for a frame. In one embodiment, the edges are sorted into an internal memory means 440 that is implemented using DRAM.

The flow of display data through the rendering engine 430 begins with an edge-processing module 548. The primary sources of edges 540 that collectively describe the required display output for a particular frame is a list of sorted edges prepared in the frame edge buffer memory 524, 526 by the display list compiler 420.

Each edge 540 in these lists contain the following fields of data:
a start X coordinate;
a start Y coordinate;
an end Y coordinate;
one or more parameters used to determine a new X coordinate of an edge corresponding to a new Y coordinate (or scan line), from a previous X and Y coordinate (or scan line). For example, this could be a delta-X value that, when added to the X coordinate of a straight edge intersecting one scan line, produces the X coordinate of that edge for the following scan line (below). Curved edges use a plurality of such parameters;
a vertical direction flag, as prepared by the filter module 504;
an address of the next edge in the list;
a reference to a left and right fill z-level.

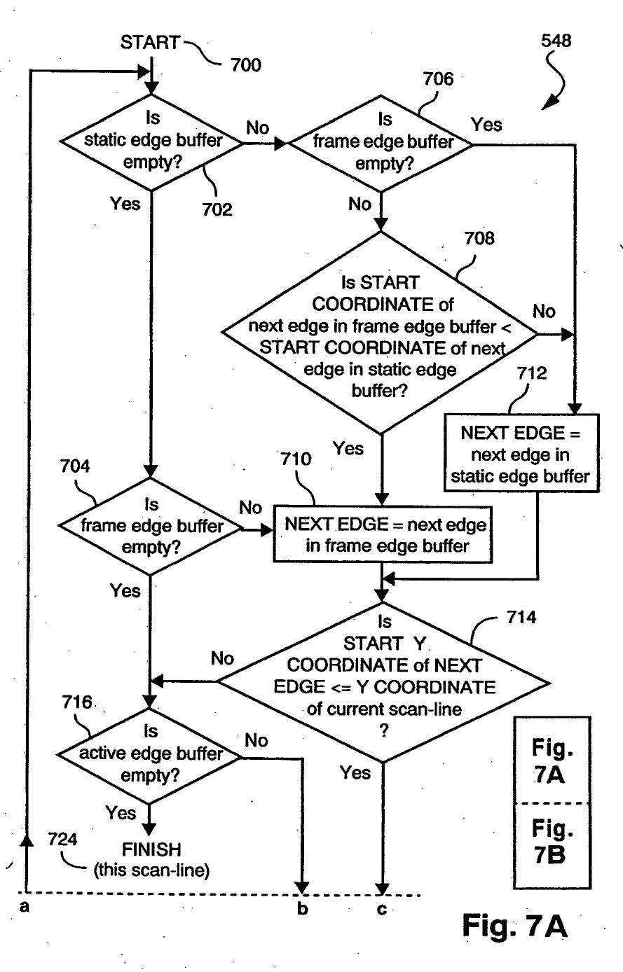

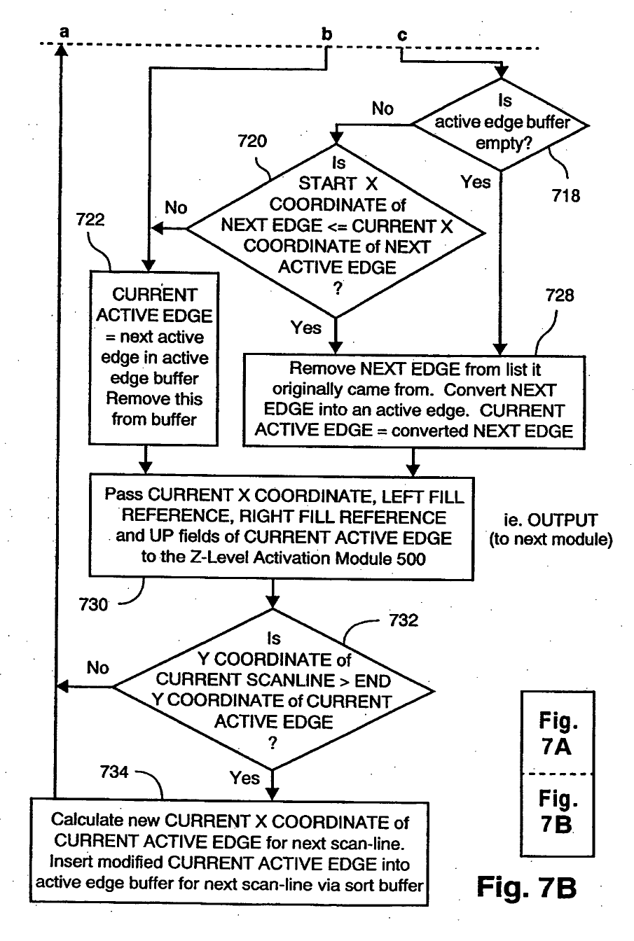

The edge-processing module 548 has two sources of edges, the first being the memory 524, 526, as described above. The second source of edges is a memory 522, 523 containing active edge buffer (1 of 2), maintained by the edge-processing module 548. The use of this and the overall operation of the edge processing module 548 will now be described with the aid of the flowcharts of FIGS. 7A and 7B which depicts method steps that may be performed by a software implementation of the edge processing module 548.

For each frame to be rendered, the edge processing module 548 operates by iterating from scan line to scan line (row to row) down the display 470. The module 548 calculates the position at which any edge in the frame edge buffer 524, 526 or a static edge buffer 528, 530 intersects the current scan line. The X position of each intersection, along with the left and right fill references of the intersecting edge, is passed to the z-level activation module 550.

FIGS. 7A and 7B show the operation of the edge processing module 548 for a single scan line. The method starts at an entry point 700. Step 702 tests if the static edge buffer 528, 530 is empty. If so, step 704 tests if the frame edge buffer 524, 526 is empty. If so, step 716 tests if the active edge buffer 522, 523 is empty. If there are no edges in any of those sources, then clearly there can be no edge intersections with the current scan line and therefore the edge processing for that scan line is complete and the method finishes at step 724. Because the frame edge buffer 524, 526 contains edges such that they are listed in scan order, then if any edges therein intersect the current scan line, they will be the next available edges of these lists. If there are edges in the static buffer 528, 530, step 706 tests the frame edge buffer 524, 526 for the presence of edges. If none, step 712 sets the next edge to be the next edge in the static edge buffer 528, 530. If edges exist in the frame edge buffer 524, 526, step 708 compares the start coordinate of next edge in the frame edge buffer 524, 526 with the next edge in the static edge buffer 528, 530. If the coordinate is greater, step 708 is followed by step 712 described above, otherwise the next edge is set instep 710 to be that from the frame edge buffer 524, 526. Step 714 follows each of steps 710 and 712 and determines if the START Y coordinate is greater than the Y coordinate corresponding to the current scan line. If so, then that edge does not intersect the current scan line and is left in the buffer for processing on a later (or lower) scan line, and control passes to step 716. Otherwise, the edge does intersect the current scan line and control passes to step 718. Unless the edge is nearly horizontal, the edge will also intersect subsequent (lower) scan lines, up to that first scan line corresponding to a Y coordinate greater than the END Y coordinate of the edge. To facilitate the process of determining intersections of that edge with the subsequent scan lines, the edge-processing module 548 converts the format of the edge such that the edge becomes what is hereafter described as an “active” edge. Rather than having data representing a START X, Y coordinate and an END Y coordinate, active edges have data representing, at least, a CURRENT X coordinate and an END Y coordinate. The current Y coordinate of the active edge is implicitly the Y coordinate of the current scan line. Active edges may also contain data (for example, a DELTA X) which enable the edge processing module 548 to calculate the X coordinate of that edge for the next scan line from the CURRENT X coordinate on the current scan line.

When the edge-processing module 548 generates an active edge from an edge that continues downwards to subsequent scan lines, this active edge will be added to a list of active edges where it will be available for processing on the next scan line. The active edge buffer 522, 523 is used to store this list. The active edge buffer is a double buffer, comprising a first buffer 522 containing the list of active edges generated for the following scan line, and a second buffer 523 containing the list of active edges already generated for the current scan line during processing of the previous scan line. Like the edges in the frame edge buffer 524, 526, the lists of active edges are in scan-order.

It is important that the edge processing module 548 process intersections in scan order, regardless of the source of the edge. For this reason, an edge from the frame edge buffer 524, 526 which intersects the current scan line, will not be processed until there are no active edges in the active edge buffer 522, 523 that intersect at a lower X coordinate. Steps 718 and 720 perform this test. Only then will the edge from the frame edge buffer 524, 526 be converted into a new active edge in step 728. The next active edge may also be derived directly from the buffer 522, 523 as determined from steps 716 and 722 in the event that the static edge buffer 528, 530 and the frame edge buffer 524, 526 are each empty.

For most scan lines, the only edges to intersect that scan line will be edges that have continued down the screen from previous scan lines. In this sense, all intersecting edges will originate in the active edge buffer 522, 523 generated by the previous scan line. In this situation, either the result of step 714 is no, or the results of 702 and 704 are both yes.

Once the source of the next intersection has been determined from step 722 or 728, a subset of data from the corresponding active edge is passed to the next module of the rendering engine 430 in step 730. That active edge is then tested to see if it continues onto a following scan line, by checking the END Y coordinate in step 732. If the active edge does continue, the CURRENT X coordinate of the active edge is recalculated for the following scan line in step 734, and the active edge is placed in the active edge buffer for the next scan line. The edge processing method returns from each of steps 732 and 734 to the start at step 700 for the next scan line.

This process of tracking the X-coordinate of an edge from scan line to scan line is often referred to as “edge tracking”. In the preferred implementation, edges are described as straight lines. For tracking edges that are straight lines, a simple per-edge delta-x adjustment is applied on each scan line.

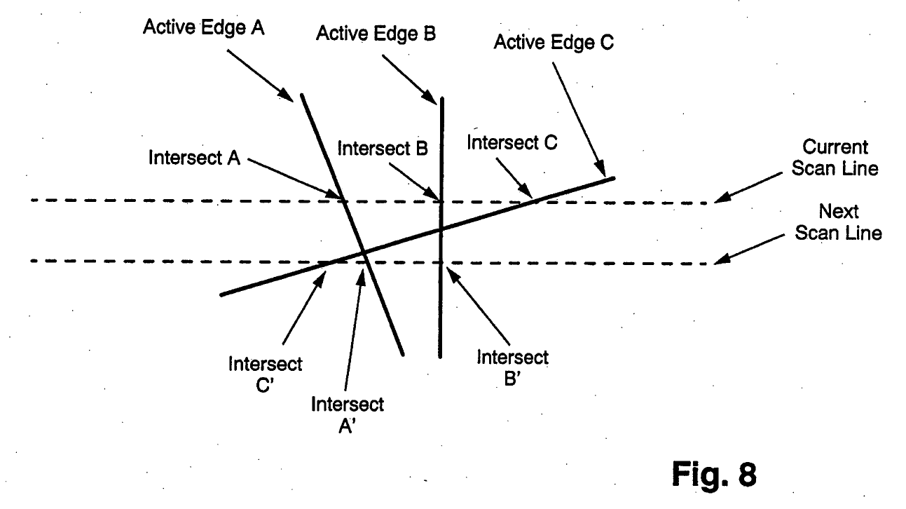

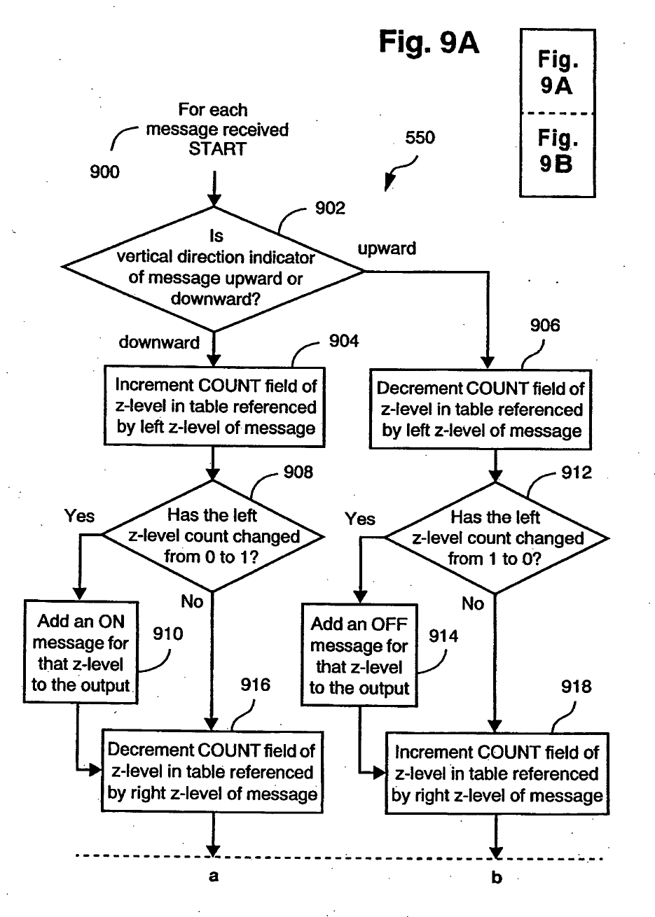

Although active edges are processed in scan-order, the result of calculating the new CURRENT X during step 734 may cause this active edge to have a lower scan position than an active edge already processed on this scan line. An example of this situation is given in FIG. 8. As seen in FIG. 8, two dashed horizontal lines represent scan lines of the output display, and the upper dashed line represents the scan line currently being processed by the edge processing module 548, and the lower dashed line represents the next scan line to be processed. The diagram shows three active edges namely, Active Edge A, Active Edge B and Active Edge C that intersect the current scan line at Intersect A, Intersect B and Intersect C, respectively. The CURRENT X field of the active edges indicate the position of the intersection. Because all the sources of edges are in scan-order, the edge-processing module will also generate output to the z-level activation module 550 in scan-order, which is what is desired. However, when the edge processing module 548 calculates new CURRENT X values for the active edges, corresponding to the intersections on the next scan line (Intersect A′, Intersect B′, Intersect C′), the scan-order of these edges is lost because Active Edge C has crossed Active Edge A and Active Edge B. The modified active edges therefore require resorting before they are placed in the active edge buffer for the next scan line. In the example of FIG. 8, the desired order of active edges in the active edge buffer 522, 523 for the next scan line is first Active Edge C, then Active Edge A, then finally Active Edge B. To overcome this, the edge processing module 548 inserts modified active edges into a sort buffer (not illustrated, but implemented in a manner corresponding to the buffers 522-530) such that they are in scan-order. The list of active edges in the sort buffer is then transferred to the active edge buffer 522, 523 for the next scan line. The subset of active edge data forming a message that is passed onto the z-level activation module 550 by the edge-processing module 548 in step 730 includes:
the X coordinate of the active edge (where it crosses the current scan line);
the reference to the fill z-levels that are associated with the active edge; and
the vertical direction indicator of the active edge.

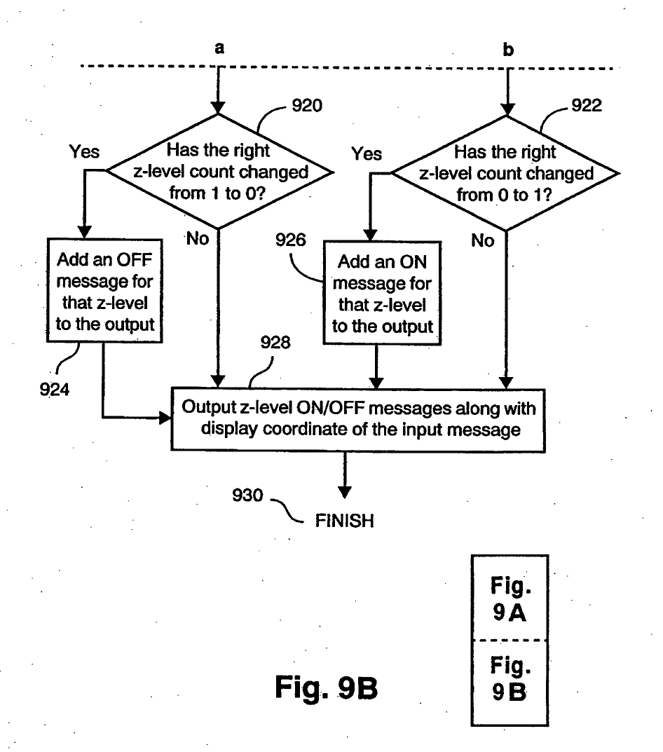

The z-level activation module 550 uses the edge intersection data passed to it from the edge processing module 548 to maintain a z-level activation table 560 that determines what fill data 532 in the fill buffer 514 contributes to the color of output display pixels. A stream of output display pixels is to be generated by the rendering engine 430 in scan order. Each intersection of an edge with a scan line represents a display coordinate for which the required output color may change when produced in scan-order. In the following descriptions, a “region” corresponds to a span of coordinates of a scan line between one intersection and a successive intersection. The pixel data of any region is determined by one or more fill data (fill styles) 532 that are referenced by z-levels in the z-level activation table 560. The data of each z-level in the z-level activation table 560 contain a count field, and a reference to the corresponding fill data 532. The count field is signed. The use of the count field is now described with reference to FIGS. 9A and 9B.

Whenever the z-level activation module 550 receives a message at step 900 from the edge-processing module 548, the count field of the z-level referenced by the message is incremented or decremented, depending on the vertical direction indicator of the message as seen in step 902. The TCIE 410 uses the “(non-zero) winding counting fill rule” to determine which z-levels of fill data contribute to output pixels. Other fill rules such as “odd/even” or “negative” may alternatively be used. A z-level is described herein as being “active” when the fill data of that z-level is required to contribute to the output pixels currently being generated by the rendering engine 430. At the beginning of processing for each scan line, the count field for all z-levels is set to 0. A z-level becomes active when the corresponding count in the z-level activation table 560 is incremented or decremented to a positive or negative value, and remains active until it returns to zero. Only those display coordinates for which z-levels become active/inactive that are critical to determining which fill z-levels contribute to a region of subsequent pixels. As such, it is only when the count field of a z-level changes zero and non-zero that a message need be passed to the following module (ie. the run culling module 552) of the rendering engine 530.

If the vertical direction indicator of a received message is “downwards” as determined at step 902, then the count field of the z-level referenced by the datum of the message is incremented in step 904. If the message is determined to be ‘upwards’ at step 902, the z-level referenced by the datum of the message is decremented in step 906. As seen from FIGS. 9A and 9B, the flowchart thereafter divides into two essentially mirror-image paths that merge at step 928.

Specifically, step 904 is followed by step 908 that tests a left z-level change from 0 to 1. If so, step 910 adds an ON message for that z-level as part of the message to the output. If not, and after step 910, step 916 decrements the COUNT field in the table for the right z-level message. Step 920 then tests the right z-level for a change from 1 to 0. If true, step 924 adds an OFF message for that z-level to the output. If not, and after step 924, step 928 outputs z-level ON/OFF messages, along with the display coordinates of the input message, to the run culling module 552. This data described the pixels runs intended for display.

In a complementary manner, step 906 is followed by step 912 that tests a left z-level change from non-zero (eg. 1) to zero. If so, step 914 adds an OFF message for that z-level as part of the message to the output. If not, and after step 914, step 918 increments the COUNT field in the table for the right z-level message. Step 922 then tests the right z-level for a change from 0 to 1. If true, step 926 adds an ON message for that z-level to the output. If not, and after step 926, step 928 outputs z-level ON/OFF messages along with the display coordinates of the input message.

The z-level activation concludes at step 930.

Steps 910 and 914 produce part of a message to the run culling module 552 indicating when a fill z-level has been turned on (activated) or off (deactivated).

Entries with a lower index in the z-level activation table 560 reference fill data that are to appear to be rendered ‘below’ entries with a higher index. For example, if a z-level with an index 1 (z-level 1) references a ‘solid red’ color, and a z-level with an index 2 (z-level 2) references a ‘solid green’ color, and these are the only two active z-levels for a region of pixels, then z-level 1 is completely obscured by z-level 2 and so that region will be rendered ‘solid green’. If, in this example, z-level 2 referenced a fill with a partially transparent color, then the region would be rendered such that the ‘solid red’ of z-level 1 would appear to partially show through the fill of z-level 2. The z-level activation table 560 may contain an additional field per entry indicating whether or not the corresponding z-level completely obscures those z-levels with lower index (ie. the corresponding z-level has a completely opaque style of fill).

In one implementation, the z-level activation module 550 performs additional functionality to reduce the time required to generate output data. Instead of outputting messages that may be used by the fill generation module 554 that indicate when any z-level has become active/inactive, the z-level activation module 550 outputs messages so that the fill generation module 554 is only informed when a subset of z-levels become active/inactive. This subset corresponds to those z-levels currently active with the highest (top-most) index. In a specific implementation, the rendering engine 430 may be configured to only allow a maximum of, say, four z-levels to contribute to the color of a region of pixels at any time. Although this compromise can introduce errors to the output, all (four) top-most active z-levels that are used to generate the fill color have to have significant transparency before this error occurs or is visible. The benefit of this restriction is that generation of fill color is guaranteed to require a maximum composition of four z-levels of fill data, rather than the composition of fill data from potentially all z-levels in the z-level activation table 560, the latter involving significantly more processing. Although this description relates to an implementation where the maximum number of z-levels for composition of the output color is four, it should be noted that such may be implemented for an arbitrary number of maximum z-levels.

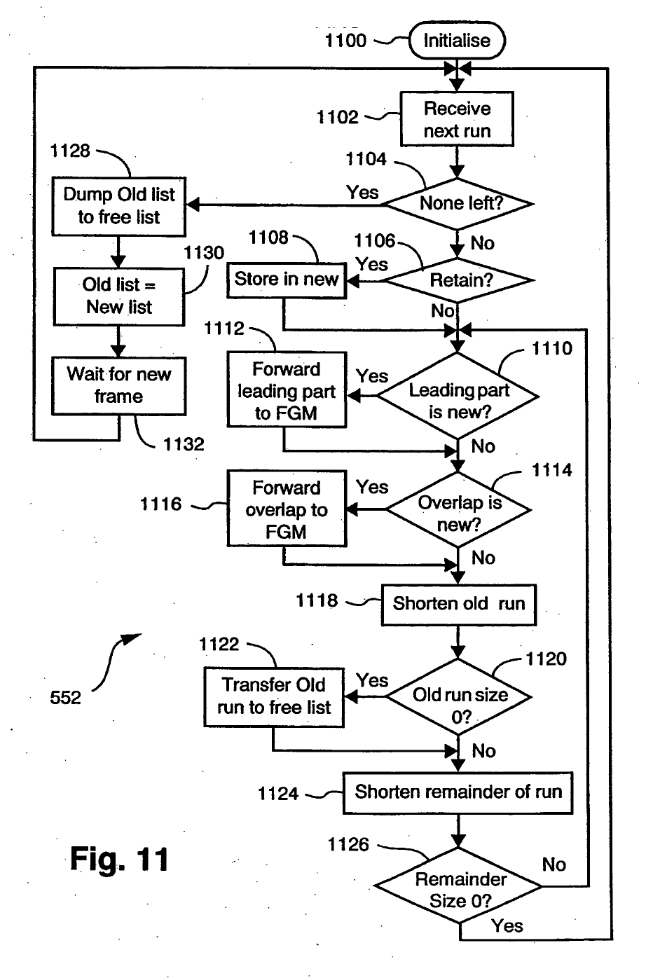

The operation of the run-culling module 552 can now be described with reference to the flowchart of FIG. 11 which is representative of a software implementation thereof. In this description a “run” refers a span of coordinates of a scan line that have a similar fill. A “fill” may be defined as a solid color such as “green”, a more complex color function such as a color ramp or radial blend, a bitmap (possibly re-sampled), or any like set of data that determines the color of each pixel in the span. The run-culling module 552 retains from the previously rendered frame a linked list of a sub-set of those runs that were used to generate that frame. For the purpose of this description, it is convenient to consider a case where that list is non-empty, where some entries have been generated from a previous frame. In the process of describing this, it will be possible to also see how runs for the current frame are retained for use in the subsequent frame.

The run culling module 552 uses a pool of run records 520 retained within the internal memory means 440 of FIG. 6B. This pool 520 is typically a fixed size chosen such that the total memory size is a fraction of the total memory size of the frame-store. For example, one quarter or one eighth of the frame-store size may be conveniently used. The run culling module 552 is deliberately throttled to record an amount that will fit in this pool 520 on the basis that storing amounts of data comparable with the size of the frame-store would take amounts of computation comparable to the direct generation of the pixels. As the whole aim of the run culling module 552 is to save time by avoiding work, any attempt to use a larger amount of memory would indicate that for the particular data concerned, the technique was not proving effective and should be avoided. Each run record in the pool 520 retains:
a link to a next run record,
a start y coordinate,
a start x coordinate,
a length, and
a fill-table index.

Run records that are not part of the current retained state are linked onto a free-list. As a frame is being rendered, run records that record the state of the frame being generated are stored on a “new retained run list”. This list becomes the “old retained run list” upon progression to the rendering of the next frame. Each list is recorded with a single list head pointer. This is established within an initialisation step 1100 as seen in FIG. 11.

When a run is received from the z-level activation module 550 in step 1102, a decision is made as to whether to record this run in the retained run pool 520. This initially involves step 1104 determining if there are any further runs. If none, step 1128 dumps the old list to a free list and step 1130 assigns the old list to be a new list. Step 1132 then awaits commencement of a new frame whereupon control returns to step 1102.

Where runs exist, step 1106 then decides whether to retain the run. This decision is based upon memory capacity as follows. The number of free run records divided by the number of remaining scan lines to be rendered is determined. This is the average number of run records (determined as a feature of design) that is desired to be handled for each remaining scan line. This is compared to the number of runs that have been recorded so far for the current scan line. If the limit has not yet been reached, a free run record from the free-list can be obtained, corresponding run details set, and the record may then be pushed onto the front of the new retained run list. This corresponds to step 1108. By this process, runs are records that contribute to the current frame for use during the generation of the next frame.

In any event (whether the present run was recorded or not) the received run is compared to the run at the head of the old retained run list in step 1110. Any leading part (or all) of this run that occurs before the start of the old retained run is forwarded to the fill generation module 554 in step 1112. Any remaining part is compared to any leading overlap between the remainder, and old retained run in step 1114. If the fill index is different, the leading part of the remainder is forwarded to the fill generation module 554 in step 1116. In any event, the old retained run is shortened at step 1118 by the leading overlap, and if that reduces its length to zero, as tested in step 1120, the whole record is transferred to the free list at step 1122. The remainder is also shortened in the same manner in step 1124. If there is still any remainder, control returns to step 1110 with the remaining part treated as if it were a received run. If not, control returns to step 1102 to handle the next received run.

Note that for portions of received runs for which a retained record was available, and the fill index is the same as it was last frame, no fill request is forwarded to the fill generation module 554, thus avoiding the considerable work associated with pixel generation. Also note that because this stage of the processing pipeline is referring to fill indices, rather than particular colors, this approach avoids passing on fill requests for all types of fills, including not just solid colors, but also color ramps and bitmaps.

When multiple overlayed transparent (or otherwise combined) objects are supported, the fill index in the above description is replace by a short array of fill indexes, up to the maximum number of simultaneous overlays supported, 4 in the described embodiment.

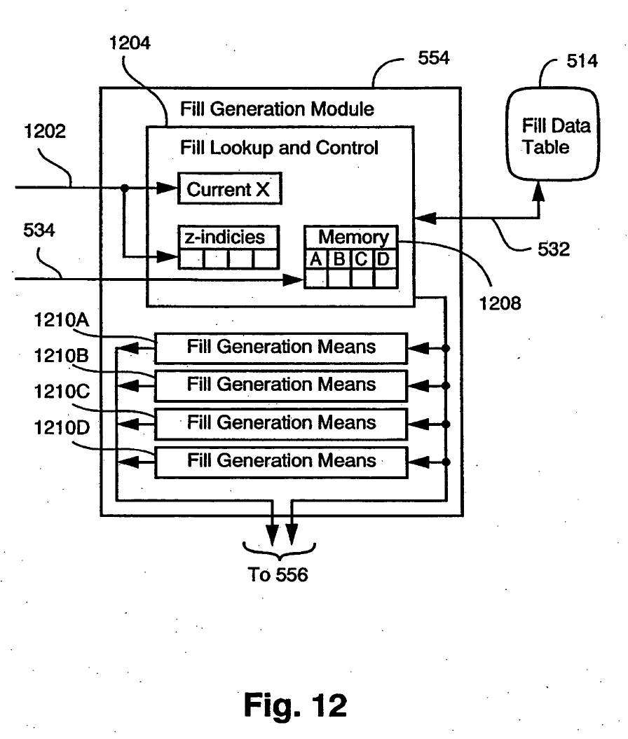

The operation of the fill generation module 554 of the TCIE 410 may now be described with reference to FIG. 12. The description that follows is for an implementation that limits the number of z-levels used to contribute to the color of a region of pixels at any time to a maximum of four. In such an implementation, the fill generation module 554 of the TCIE 410 has four means 1210 (1210A-1210D) of fill generation that can generate data. These fill generation means 1210 are controlled by messages from the run-culling module 552 described above. The output of a fill generation means 1210 is a datum describing the pixel color required for the associated z-level for the current display coordinate being rendered. The pixel color data of each fill generation means 1210 are passed to the region compositing module 556, which blends the colors generated for each active z-level to produce the required output pixel data for display.

The messages from the run-culling module 552 include the following data:
an X display coordinate; and
the indices of the z-levels that become active at that coordinate.

As seen in FIG. 12, the fill generation module 554 includes a fill lookup and control module 1204 that couples to the fill data table 514 and the z-level table 516, 518. The module 554 receives the above noted messages at an input 1202 from the run culling module 552, the values for which are retained in the module 1204.

The fill generation module 554 maintains a memory means 1208, such as a hardware register or software variable, that indexes each of the four fill generation means 1210 to a z-level in the z-level activation table 560. When a message is received that deactivates a z-level, then the fill generation means 1210 associated with that z-level, by means of the corresponding index is disassociated with that z-level. A fill generation means 1210 not associated with a z-level does not produce pixel data. When a message is received indicating a z-level has become active, then one of the fill generation means 1210 that is not already associated with a z-level becomes associated with that z-level that has become active.

There are two sources of fill data used by each fill generation means 1210, a first source being the z-level table 516, 518, and a second source being the fill data memory 514. The z-level table 516, 518 is double buffered, and the buffers 516, 518 are swapped when the rendering engine has finished rendering a frame. While a first buffer 516 containing a first fill table is being prepared by the display list compiler, a second buffer 518 that was prepared by the display list compiler during rendering of the previous frame is read from by each fill generation means 1210. The z-level table 516, 518 provides indirection between an index to a z-level and the corresponding data (stored in the fill table) that is required to produce pixel data for that z-level. The z-level table contains one entry per z-level, and an entry in the z-level table has a corresponding entry in the z-level activation table 560 with the same index. Each z-level table entry includes a reference to fill data 532 in the fill data memory 514. Each z-level table entry may additionally contain:
A flag (NEED_BELOW) indicating whether or not the fill data for that z-level is opaque; and
A flag (X_INDEPENDENT) indicating whether the fill data is dependent upon variation in the X position (eg. a bitmap or a blend), or the fill data remains constant (eg. a single-color fill).

The above additional flags enable the fill generation module 554 to minimize the required processing of fill data.

For a z-level that references a simple single-color fill, the fill data 532 in the fill table 514 will simply be a color description, for example, comprising a red, a green, a blue and an alpha (transparency) component. Fill data for a gradient fill may be implemented as a table of colors, and additional parameters that are used to produce an index into this table from the current output display coordinate.

The data stored for a gradient fill in the TCIE 410, and how a fill generation means 1210 of the fill generation module 554 operates to produce output data, can now be described. The fill data for a gradient is implemented as a table of 17 colors. A value between 0 and 255 is used to index this table of 17 colors, such that each successive color entry in the table is associated with an index value 16 greater than the previous. As such, the first entry has an index of 0, the second entry has an index of 16, etc., up to the last entry having an index of 256. A color corresponding to an index that is not a multiple of sixteen can be linearly interpolated from two adjacent colors in the table with indices closest to that required. Fill data for a gradient also requires parameters that indicate how an index to the color table can be obtained for a particular display coordinate.

When an object is placed on the target display 470 by the TCIE 410, the object edge data will be transformed such that the edges correspond to display coordinates. It is therefore necessary that any gradient fill contained by edges of the object be also transformed, so that the appearance of the gradient (eg. position and orientation) is consistent relative to the object.

To minimize the required calculations for determining a color table index for each display coordinate, the TCIE 410 implements the concept of a bounding box, in display coordinates, for fill data 532. The bounding box describes a rectangular region of the display, with two edges parallel to the display coordinate X-axis, and two edges parallel to the display coordinate Y-axis. In one implementation of the TCIE 410, a bounding box forms part of the fill data 532 in the fill table 514 for a gradient fill.

For a linear gradient fill, a data in the fill table 514 additionally contains a start index into a color table. The start index represents the output color of a fill for the display pixel nearest the top-left hand corner of the bounding box. The fill data 532 also contains a delta-X value and a delta-Y value. The delta-X value is used to increment the start index to obtain a new index into the color table for the next pixel (or X-coordinate of iteration) to the right. This forward-incrementing of the index continues as display pixel datum are generated from left to right along a scan line, thus producing a linear gradient of fill color from the fill table up to the right-hand side of the bounding box. The delta-Y value is used to increment the start index into the color table to obtain a start index for the left-hand side of the bounding box on the following scan line. Together, the start index, delta-X, delta-Y and the bounding box provide the means for producing a variety of linear gradient fills from a color table. The values start index, delta-X and delta-Y will normally be implemented as an integer and fractional parts (eg. fixed-point values). Fill data 532 in the fill table 514 can be modified by an instruction (eg. INST_WRITE_FILL described above). This enables the parameters of a gradient fill to be modified whenever necessary such that the orientation, position and scale of the gradient fill remains consistent with the orientation, position and scale of a containing object.

In one implementation, data for a gradient fill does not include a bounding box. Instead, the bounding box of an object containing that gradient fill is calculated dynamically by recording the minimum and maximum values of X and Y for each edge as it is placed. The start index, delta-X and delta-Y values are provided with respect to this bounding box. These maximum/minimum recordings ensure that the TCIE 410 can maintain a bounding box describing a rectangular region of the display with two edges parallel to the X-axis of display coordinates, and two edges parallel to the Y-axis of display coordinates, collectively containing all edges of an object. An advantage of this implementation is that bounding box data does not consume the fill data table 514, and the bounding box is recalculated by the TCIE 410 with little additional processing, rather than requiring instructions (also consuming memory means or host processor effort) to update the bounding box in the fill table 514.

The fill generation module 554 may also implement a fill based on a bitmap image. A similar technique to that described for gradient fills is used. Again, the bitmap fill relies on a bounding box being defined, either as part of the object containing the fill, or as part of the data describing the fill in the fill table. Values for pixels within the bounding box are determined from values for pixels defined in a bitmap image. This bitmap image is referenced by the fill data 532 for the bitmap fill. As for gradient fills, the bitmap fill must be drawn with an orientation, position and scaling that is consistent with the orientation, position and scaling of a containing object. To permit this, bitmap fill data in the fill table may be overwritten (via instructions fetched from a memory means 306, 309 or the host processor 450) to control how display data is retrieved from the source bitmap of the bitmap fill. The operation of a fill generation means 1210 for generating a bitmap fill is similar to the operation for generating a gradient fill in that data is calculated incrementally for pixels within a bounding box. Whereas gradient fills incrementally calculate a color table index, the bitmap fill incrementally calculates the memory address of a pixel in a source bitmap. The parameters for a bitmap fill in the fill table 514 include:
bitmap Start X and Bitmap Start Y coordinates;
Delta X and Delta Y;
Delta Scan Line X and Delta Scan Line Y; and
Max X and Max Y. The parameters may also include:
Bitmap Base Address; and
an indication of number of bytes per pixel used in the source bitmap.

The Bitmap Start X and Y coordinates correspond to a position within the source bitmap. The coordinates have sub-pixel accuracy, that is to say they have an integer part that references a pixel within the source bitmap, and a fractional part that relates to a position within that pixel. The fill generation means 1210 producing a bitmap fill stores Start X and Start Y into a local memory means before the rendering engine 430 has to produce data for the pixel closest to the top-left of the bounding box. Start X is stored in two local memory means (eg. registers), referred to hereafter as Current X and Line Start X. Start Y is stored in two local memory means referred to hereafter as Current Y and Line Start Y. Current X and Current Y are signed and have an integer and a fractional part. Current X and Current Y reference a current position within the source bitmap, and therefore a corresponding pixel color. A fill generation means 1210 generating a bitmap fill will use this pixel color as the current display output color. As the rendering engine 430 iterates to the next pixel to the right along a scan line, the fill generation means 1210 increments Current X by the value Delta X of the bitmap fill data, and increments Current Y by the value Delta Y of the bitmap fill data. By this means, the coordinates of pixels in the source bitmap can be traced at the required rate and in the required order for rendering the output.

After the rendering engine finishes outputting data for a scan line, new values of Line Start X and Line Start Y are calculated, so that they represent a position in the source bitmap corresponding to where the left-hand side of the bounding box meets the next scan line on the output display. The fill generation means 1210 does this by incrementing Line Start X by Delta Line Start X, and incrementing Line Start Y by Delta Line Start Y. These new values for Line Start X and Line Start Y are also loaded into Current X and Current Y, which again track positions in the bitmap for the new scan line.

The parameters of the bitmap fill data, Max X and Max Y, are integer values indicating the dimensions of the source bitmap. When the fill generation means 1210 detects that the locally stored Current X and Current Y values exceed Max X and Max Y, then a new Current X and Current Y is calculated by subtracting Max X and Max Y from them respectively. Similarly, if Current X and Current Y become less than zero, a new Current X and Current Y is calculated by adding Max X and Max Y to them respectively.

The address of a source pixel can be determined from Current X and Current Y using the Bitmap Base Address and number of bytes per pixel from the bitmap fill data using the formula:
Pixel address=Bitmap Base Address+(floor(Current Y)×Max X+floor(Current X))×num. Bytes per pixel;
where floor(Current X) and floor(Current Y) are the integer parts of Current X and Current Y respectively.

This calculation involves the undesirable requirement of performing two multiplications per output pixel of fill data. This is overcome in the preferred implementation as follows.

The fill generation means 1210 stores a ‘Current Address’ value in a local memory means, corresponding to the address of a pixel in the source bitmap that is referenced by the coordinates maintained in Current X and Current Y. This is initially loaded with a ‘Start Read Address’ value, provided as an additional parameter of the bitmap fill data in the fill table. Each time Current X and Current Y are incremented as the rendering engine iterates along a scan line, Current Address can also by incremented to determine the address of the next required pixel in the source bitmap. The amount by which Current Address needs to be incremented, however, depends on whether or not the fractional parts of Current X and Current Y produced a ‘carry’ into their respective integer parts when they were incremented. The required increment of Current Address will be one of the following four values shown below:
If fractional Current X did not carry and fractional Current Y did not carry, increment=bytes per pixel in bitmap×(integer part of Delta X+(integer part of Delta Y×Max X));
If fractional Current X did carry and fractional Current Y did not carry, increment=bytes per pixel in bitmap×(integer part of Delta X+1+(integer part of Delta Y×Max X));
If fractional Current X did not carry and fractional Current Y did carry, increment=bytes per pixel in bitmap×(integer part of Delta X+((integer part of Delta Y+1)×Max X)); or
If fractional Current X did carry and fractional Current Y did carry, increment=bytes per pixel in bitmap×(integer part of Delta X+1+(integer part of Delta Y+1×Max X)).

The fill generation module 554 may require these four possible increment values to be provided as pre-calculated data in the bitmap fill data. The fill generation means 1210 determines which increment to use depending on the result of incrementing Current X and Current Y.

The same technique described above is used when tracking the Current Address between the end of one display scan line and the next. When the fill generation means 1210 initially stores the ‘Start Read Address’ value into the Current Address memory means, it also stores ‘Start Read Address’ into a further memory means hereafter referred to as ‘Line Start Address’. This address is the address of a pixel in the source bitmap referenced by Line Start X and Line Start Y. As Line Start X and Line Start Y are incremented when the rendering engine iterates to a new scan line, so also Line Start Address is incremented, and the resulting value written to Current Address. Again, the required increment will be one of four values depending on whether or not a ‘carry’ occurs during the incrementing of either of Line Start X and Line Start Y. The TCIE 410 may require these four possible increment values to be provided as pre-calculated data in the bitmap fill data.

The TCIE 410 allows source bitmaps to be provided in memory as either a single bitmap or as a plurality of smaller “tile” bitmaps that are referenced by a list or array. In the latter representation, the “tile” bitmaps occupy arbitrary locations in memory, and a list or array is used to reference these in scan order, so that a tile corresponding to the top-left of the whole bitmap image is referenced first. In one embodiment the tile dimensions can either be 16 pixels by 16 pixels or 32 pixels by 32 pixels. The advantage gained by storage tiling becomes evident when the TCIE 410 requires a limited region of a large source bitmap when rendering. Only the tiles required for that region need to be available in local memory. Furthermore, since tiles represent localised regions of the image, and since tiling ensures the data for these regions are stored in adjacent memory, iterative pixel operations such as rotation can be performed without frequent random-sized jumps in memory. This is particularly desirable if the memory means for a bitmap is DRAM, in which memory-page changes incur significant latency. The use of tiles for representing a bitmap is particularly useful if it cannot be guaranteed that all tiles for an image are available when required, since the array or list of references to the tiles can indicate absence, and action can be taken to minimize this contingency.

Each fill generation means 1210 of the fill generation module 554 produces output pixel data corresponding to a z-level (of the z-level table) that was determined to be active by the z-level activation module (possibly filtered by the run-culling module). A plurality of output pixel data is passed to the region compositing module 556 by means of a message. The fill generation module 554 will produce a message when the output data of any of the fill generation means 1210 changes. For example, if the z-level activation module 550 passes a message to the fill generation module 554 indicating a z-level has been deactivated, the fill generation module 554 responds by deactivating the fill generation means 1210 associated with that z-level, and passing a message to the region compositing module indicating this has occurred.

Messages passed to the region compositing module 556 include an X display coordinate and a plurality of pixel data corresponding to the current topmost active z-levels being rendered. It has already been noted that the fill table 514 may contain a flag ‘NEED_BELOW’, indicating whether or not the fill data 532 of the associated z-level has at least some transparency. If one of the fill generation means 1210 produces data for a z-level in the table with a NEED_BELOW flag set to false (ie. cleared), then the fill generation module 554 need not pass pixel data to the region compositing module 556 for any z-levels with a lower index.

The purpose of the region compositing module 556 is to combine the pixel data of received messages into a single color value that will be passed to the frame store 160 or display 470. The region compositing module 556 reads the pixel data such that the pixel datum associated with the lowest z-level is read first. The next highest z-level is then read, and the transparency component of this is used as a weighting factor to blend this higher z-level color with the previously read lower z-level color. For example, if the pixel datum for z-levels comprise of three (red, green and blue) color components and a fourth transparency component with a value in the range 0 to 255, then each color component from the two z-levels is blended using the formula:
C=((C_{higher}×a)+(C_{lower}×(255−a)))/255
where a is the transparency component, and where a=255 describes completely opaque pixel data, a=0 describes completely transparent pixel data.

The new pixel data obtained by the result of this blend is then combined with the data of the next highest z-level of the message using the same means. This continues until all z-levels of the message have been combined.

The results of these operations collectively describe the display update for a frame as a series of runs, where each run is specified by a START X, Y coordinate, a length, and pixel color values. Where the run-culling module 210, 552 is omitted, runs that cover every pixel of the frame-buffer will be produced. However, with the inclusion of the run-culling module 210, 552, far fewer such runs are produced, thus saving considerable computation time both in terms of run generation and the painting of runs into the frame-buffer 160 or display 470.

As indicated above, operation of the run-culling module 552 is optimised based upon the storage requirements of the retained run list 220 (or pool 520). In practical implementations, operating criteria are preferably established so that performance is not deteriorated below the worst case—this being equivalent to omission of the run culling operations. This is certainly the case where memory availability expires according to the above-mentioned formulation. An example of this can be understood by returning to FIG. 10 and assuming that memory requirements were exceeded and resulted in the over-writing of the record relating to span A3. If such occurred, the span B3 would need to be rendered in its entirety. However, a saving would nevertheless have been obtained through the retention of A1 and A4, which are both replicated in frame B, and in part for span A2, much of which is replicated by span B2.

The present inventors have also determined that, due to processing overhead, that the run culling operations described herein offer no appreciable saving for very small runs of, say less than 32-64 pixels. However, for simple “cartoon” style animation with opaque objects, experiments have indicated rendering processing time saving of up to 80%.

Further, whilst the example of FIG. 10 relates to opaque objects, the principles disclosed herein are equally applicable to objects having transparency components. In such instances the only difference in rendering is the number of active objects passed to the fill generation module 554 (limited to 4 in the described implementation) and the additional processing required to be performed by the region compositing module 556 to account for object transparency.

### INDUSTRIAL APPLICABILITY

The arrangements described are applicable to the computer and data processing industries where rendering of animated images is required. An example of this lies in portable game devices and particularly those where gaming is performed over a communications network, such as shown in FIG. 3 with respect to a game played upon the telephone handset 350. In such instances, much of the processing depicted in FIGS. 6A and 6B may be performed by a server computer within the network 320, and with the handset 350 being used to input user commands to the server. The server may then interpret those commands to form the instructions 460, objects 462 and fills 464, pass the fill data 532 and z-level data 534 to the handset 350, and perform rendering operations up to and including run culling 552. The server may then output the run whereupon the handset 350 performs fill generation and compositing to the display 352. Such minimises the computational overhead of the handset 350, thereby reducing capital cost and extending battery lifetime, whilst optimising processing speed and interactivity within the server. This is particularly important when playing games between handset users. An alternative mode of operation is to transfer graphic objects, or updates to graphic objects, from the network 320 to the telephone handset 350 and to implement the entirety of the render pipeline within the handset 350.

Whilst in FIG. 3, the remote device is a portable telephone handset 350, other devices, which need not be portable may be used. Examples include those where a display is fixed for a specific purpose, such as a computer driven advertising display, or a display forming part of the operational control of a device, such as a copying machine.

The foregoing describes only some embodiments of the present invention, and modifications and/or changes can be made thereto without departing from the scope and spirit of the invention, the embodiment(s) being illustrative and not restrictive.

1. A method of rendering a series of raster image frames from object graphic elements, characterized in that at least one old fill run is retained during the rendering of a first frame and said retained fill run is compared with at least one new fill run required for a subsequent frame and for at least one said new fill run suppressing the generation of pixel data for at least part of said new fill run and instead using pixels retained from said first frame.

2. A method according to claim 1, wherein descriptions of said retained fill runs are stored in an ordered list.

3. A method according to claim 2, wherein a number of retained fill run descriptions is limited to less than a number required for a complete reproduction of said first frame.

4. A method of rendering a plurality of raster image frames each having a plurality of pixels, said method comprising the steps of:
(a) rendering a first frame and retaining first data describing fill runs of pixels of said first frame; and
(b) rendering a second frame to update the pixels of said first frame, said rendering of said second frame comprising the sub-steps of:
(ba) determining second data describing fill runs of pixels of said second frame;
(bb) comparing said second data with said first data; and
(bc) generating new pixels using said second data, and over-writing pixels in said first frame, when said comparison indicates a different pixel value would result.

5. A method according to claim 4, wherein said first data is retained in an ordered list.

6. A method according to claim 5, wherein the amount of said first data retained in said list is limited to less than a number required for a complete reproduction of said first frame.

7. A method according to claim 4, wherein step (b) comprises the further sub-steps of:
(bd) updating said first data with said second data corresponding to said new pixels;
(be) if the comparison of step (bb) indicates the same pixel value will result, reproducing the corresponding pixels of the first frame in the second frame; and said method comprises the further step of:
(c) repeating step (b) for a subsequent frame.

8. A method according to claim 7, wherein said data describing each said fill run comprises at least a list of graphic object priorities that contribute to pixels in said run, and a length of said run.

9. A method according to claim 8, wherein said list is limited to a predetermined number of highest priority objects.

10. A method according to claim 8 or 9, wherein step (bb) comprises comparing data for said fill runs in order along a scan line of said frame.

11. A method according to claim 10, wherein said comparing comprises:
(bba) comparing those contributing object priorities of said second data with those of said first data:
and if the same:
(bbaa) comparing the length of the corresponding runs, and if the same, step (be) comprises (bea) reproducing the pixels of the first frame for said run and discarding said second data; and if not the same, step (be) comprises (beb) reproducing the pixels of the first frame for a span corresponding to the smaller of the two lengths, updating the length of said run in the first data by said smaller length, and forming a new run from said second data corresponding to the contributing priorities of said second data and the remaining length being the difference between said two lengths; andand if not the same: (bbab) determining pixel values from said second data for said second frame.

12. A method according to claim 1 or 4, wherein said rendering is performed on a scan line-by-scan line basis.

13. An apparatus for rendering a series of image frames, said apparatus being configured to perform the method of claim 1 or 4.

14. A computer readable medium having a computer program recorded thereon for rendering a series of image frames according to the method of claim 1 or 4.

15. A sequence of image frames formed using the apparatus according to claim 13.

16. An apparatus for rendering a sequence of raster image frames each having a plurality of pixels, said apparatus comprising:
a renderer configured for rendering an image frame of said sequence and retaining data describing fill runs of pixels of said frame; and
means for determining further data describing fill runs of pixels of a next image frame in said sequence;
means for comparing said further data with said retained data; and
means for rendering new pixels using said further data, and over-writing pixels in said image frame to form said next image frame, when said comparison indicates a different pixel value would result.

17. An apparatus according to claim 16, wherein said retained data and said further data each comprise data corresponding to each said run of pixels in the corresponding image frame.

18. An apparatus according to claim 17, wherein said means for comparing compares data for a like run of pixels between said image and further frames.

19. An apparatus according to claim 16, further comprising means for retaining said retained data as an ordered list.

20. An apparatus according to claim 19, wherein the amount of said data retained in said list is limited to less than a number required for a complete reproduction of said first frame.

21. An apparatus according to claim 16, further comprising:
means for updating said retained data with said further data corresponding to said new pixels;
means for reproducing the corresponding pixels of the image frame in the further frame if said means for comparing indicates the same pixel value will result; and
means for repeating operation of said apparatus for subsequent frames of said sequence.

22. An apparatus according to claim 21, wherein said data describing each said fill run comprises a list of graphic object priorities that contribute to pixels in said run, and a length of said run.

23. An apparatus according to claim 22, wherein said list is limited to a predetermined number of highest priority objects.

24. An apparatus according to claim 22, further comprising means for further comparing data for said fill runs in order along a scan line of said frame.

25. An apparatus according to claim 24, wherein said means for further comparing comprises:
first means for comparing those contributing object priorities of said further data with those of said image data;
second means, operative when said first means determines said priorities to be the same, for comparing the length of the corresponding runs;
third means, operative if said second means determines said lengths to be the same, for reproducing the pixels of the image frame for said run in said further frame and for discarding said further data;
fourth means, operative if said second means determines said lengths to be different, for reproducing the pixels of the image frame for a span of pixels corresponding to the smaller of the two lengths, for updating the length of said run in the image data by said smaller length, and for forming a new run of pixels from said further data, said new run corresponding to the contributing priorities of said further data a remaining length being the difference between said two lengths; and
fifth means, operative when said first means determines said priorities to be different, for determining pixel values from said further data for said next image frame.

26. An apparatus according to claim 16, wherein said rendering is performed on a scan line-by-scan line basis.

27. A computer readable medium, having a program recorded thereon, where the program is configured to make a computer execute a procedure to render a plurality of raster image frames each having a plurality of pixels, said program comprising:
code means for rendering a first frame and retaining first data describing fill runs of pixels of said first frame; and
code means for rendering a second frame to update the pixels of said first frame, said code means for rendering of said second frame comprising:
code means for determining second data describing fill runs of pixels of said second frame;
code means for comparing said second data with said first data; and
code means for generating new pixels using said second data, and over-writing pixels in said first frame, when said comparison indicates a different pixel value would result.

28. An apparatus for rendering a sequence of image frames each formed of a plurality of pixels, said apparatus comprising:
means for receiving from a host, fill and priority data related to graphic objects available for rendering by said apparatus;
a display device upon which said sequence of image frames is to be reproduced;
means for receiving, from said host, limited data describing runs of pixels in each said image frame, said limited data including those said objects that contribute to pixel values within the corresponding said run; and
means for rendering, for each said run, the corresponding said objects using said limited data and said fill and priority data, to provide pixel values for said corresponding frame for display on said display device.

29. An apparatus according to claim 28, further comprising:
means for retaining said limited data for a current one of said frames, said rendering being performed for a frame from said retained limited data; and
means for updating said retained limited data for at least one run of pixels for a following said frame where said updated retained limited data relates to those runs of pixels that change compared to the preceding frame,
wherein said means for rendering is operative for said following frames upon the updates of said limited data.

30. An apparatus according to claim 29, further comprising:
a user interface for receiving user commands; and
means for communicating said user commands to said host to influence generation of said limited data.

31. An apparatus for processing image data defining a sequence of displayable image frames each formed of a plurality of pixels, said apparatus comprising:
means for transmitting to a remote device, fill and priority data related to graphic objects forming part of said image data and available for rendering by said remote device;
means for determining from said image data, limited data describing runs of pixels in each said image frame, said limited data including those said graphic objects that contribute to pixel values within the corresponding said run of pixels;
means for comparing said limited data for a current said frame with said limited data for an immediately preceding frame to identify that said limited data for said current said frame that has changed; and
means for transmitting said changed limited data to said remote device for rendering said current frame.

32. An apparatus according to claim 31, further comprising:
means for receiving commands from said remote device; and
means for processing said commands to alter said image data.

33. (Cancelled)
